(19) United States
(12) Patent Application Publication
(10) Pub. No.: US 2016/0252344 A1
(43) Pub. Date: Sep. 1, 2016

(54) Self referenced intensity-based polymer optical fibre displacement sensor

(71) Applicant: Nano and Advanced Materials Institute Limited, Hong Kong (HK)

(72) Inventor: Kai Tai WAN, HK (HK)

(21) Appl. No.: 14/633,146

(22) Filed: Feb. 27, 2015

(51) Int. Cl. G01B 11/14; G02B 6/02; G02B 6/26

(52) U.S. Cl. CPC G01B 11/14; G02B 6/262; G02B 6/02033

(57) ABSTRACT

The present invention provides a self-reference and tunable optical displacement transducer comprising an optical splitter, at least one transducing element and a self-reference element, where each of said transducing element and said self-reference element comprises a pair of optical fibers and a reception assembly between each pair of the optical fibers. One of the reception assembly and the second optical fiber of the transducing element are displaceable along the same axis and relatively with respect to each other while another reception assembly and the second optical fiber of the self-reference element are non-displaceable. Incorporation of the self-reference element into the present transducer enables monitoring and measuring crack size and integral strength of a structure without being affected by other environmental or external factors.

### CROSS REFERENCE TO RELATED APPLICATIONS

The present application claims priority of U.S. provisional patent application Ser. No. 61/998,126 filed Jun. 19, 2014, and the disclosure of which is incorporated herein by reference in its entirety.

### FIELD OF THE INVENTION

The present invention relates to an optical displacement transducer incorporated with a self-reference element for measuring and monitoring crack size of a structure. The present invention also relates to a method of determining crack size of a structure using the optical displacement transducer incorporated with the self-reference element to eliminate other environmental or external factors than displacements due to the crack.

### BACKGROUND OF THE INVENTION

Optical displacement transducers that exploit optical fibers have several advantages, such as light weight, small size, multiplexed and immunity to electromagnetic interferences. The latter property is particularly interesting because it allows the application to critical environments such as infrastructure with high power cable. Of great importance is also the small size that can be fitted into structures with minimum disturbance. Such transducers are in general based on the principle of insertion loss that includes two optical fibers, each is cleaved to have end faces substantially perpendicular to an axis and positioned with a small gap between the end faces of the fibers. To tune the sensitivity of the transducer, the small gap can be filled with transparent solid, liquid, gas or mixture of them. One fiber is mounted to maintain its end face stationary, for example, while the other is allowed to move along the fiber axis. When the fiber axes lie on a common straight line, light propagating in one fiber will couple with maximum intensity into the other fiber.

An example of application of such an arrangement for measuring displacements is disclosed in the U.S. Pat. No. 7,323,678, where is provided an optical displacement transducer. It uses similar principle of the present invention. However, the sensitivity of which is not tunable. Also, additional temperature sensor is required to overcome the fluctuation of light intensity of the light source due to temperature change. To overcome these problems, an innovative solution to tune the sensitivity of the optical displacement transducer and provide self reference for fluctuating light source is needed.

A similar transducer is also disclosed in the Japanese publication JP8285709. Such transducers, however, being based on a radial displacement detection, only allow for measuring displacements up to the fiber core dimension, since the received power goes to zero once the two fibers are no longer aligned. This means that even using commercial multimode glass fibers having a core diameter of about 1,000 micrometers, such transducers just allow for measuring maximum displacements of about 1,000 micrometers. To overcome such a limitation, it is necessary to use more expensive fiber bundles, but it makes alignment of every fiber more difficult.

### SUMMARY OF THE INVENTION

An object of the present invention is to provide an improved transducer which allows for measuring displacements with self referencing function that is insensitive to fluctuation of the intensity of light source and tune the sensitivity and measurement range in a cost-effective way. The object is achieved by means of using an optical splitter, a transducing element and a self referenced element having the features set forth herein.

Accordingly, the first aspect of the present invention relates to a self-reference and tunable optical displacement transducer including an optical splitter, at least one transducing element and a self-reference element, said optical splitter comprising one inlet and at least two outlets, the optical fiber in the inlet further comprising at least one light source coupled for transmission and split into at least two separated optical paths in the outlets and the proportion of light intensity in each of the outlets compared with the inlet is fixed; each transducing element comprising a first optical fiber and a second optical fiber, said first optical fiber having a first end face aligned along an axis and positioned in one of the outlets of optical splitter, a second end face of the first optical fiber from the outlet aligned along an axis and positioned with a small gap between said second end face of the first optical fiber and a first end face of a first reception assembly, the small gap is filled by transparent solid/liquid/gas; said transducer further comprising at least one photo-detector coupled for reception to said first reception assembly, said second optical fiber of the transducing element and said first reception assembly being displaceable along said axis and relatively with respect to each other; said self-reference element comprising a first optical fiber and a second optical fiber, said first optical fiber having a first end face aligned along an axis and positioned in one of the outlets of the optical splitter, a second end face of the first optical fiber from the outlet aligned along an axis and positioned with a small gap between said second end face and a first end face of a second reception assembly, the small gap is filled by transparent solid/liquid/gas; said transducer further comprising at least one photo-detector coupled for reception to said second reception assembly, said second optical fiber of the self-reference element and said second reception assembly being non-displaceable along said axis.

The second aspect of the present invention relates to a corresponding displacement measuring system as well as to a corresponding displacement detection method. In brief, the displacement measurement system is built around a low cost fiber optic transducer connected to electronic circuitry for the signal conditioning and elaboration. The corresponding displacement detection method comprises using the transducer to convert the measure of a displacement into a measure of a variation of current or voltage by exploiting the variation in the photo-current detected at the output of a fiber optic system with link attenuation. In order to control the sensitivity of the transducer, two optical fibers are faced so that they are coupled through a small gap filled by solid, liquid, gas or the mixture thereof, and the separation of the gap can be changed by moving the two optical fibers relatively along their axes. To become self referencing, another two optical fibers are coupled identically as the aforementioned transducer. However, the another two optical fibers cannot be moved relatively. Any fluctuation of the intensity of the light source induces identical effectives on both the transducing element and self-reference element. The displacement can be deduced from the ratio between the transducing element and self-reference element.

The corresponding displacement measuring system and detection method allow the measurement of displacements in the order of at least five times, e.g., can be up to several ten times the fiber core diameter. The minimum crack size of a structure to be measured and detected by the present invention can be as low as 1 mm.

In an embodiment of the invention, polymer optical fibers (POF) having large core diameter and high numerical aperture is used as the fiber optic transducer of the present invention. Core diameter of the POF used in the present invention ranges from 400 to 1,100 μm; numerical aperture of the POF is about 0.5. The light sources and photo-detectors for the operation of the transducer and self-reference element can be off-the-shelf LEDs and photodiodes, while the elaboration can be provided through a simple personal computer equipped with a digitizing card (DAQ) or a standalone microcontroller such as Arduino, through a low noise multiple channel amplifier. The whole setup can be extensible to wireless sensor network easily.

### BRIEF DESCRIPTION OF THE DRAWINGS

FIG. 1 shows a schematic diagram of the self-referenced tunable displacement transducer being installed under a bridge deck according to an embodiment of the present invention.

FIG. 2 shows a schematic diagram of an optical splitter with one inlet and two outlets according to an embodiment of the present invention.

FIG. 3 shows a linear relationship of the displacement measured in linear variable differential transformer and the loss in optical intensity in log-scale through the self-referenced tunable optical displacement transducer of the present invention: (A) is a plot of the optical power loss in log-scale measured by the photo-detector against the displacement of the first reception assembly where the small gap in the coupler is filled with air; (B) is a schematic diagram illustrating cone size of light outputted from the second end face of the first optical fiber of the transducing element through different materials filled into the small gap in the coupler; (C) is a hypothetical plot of the optical power loss in log-scale against the displacement of the first reception assembly when using transparent solid (polydimethylsiloxane) and liquid (optical gel) predicted based on the linear curve in (A) where air is used to fill the small gap in the coupler.

### DETAILED DESCRIPTION OF THE INVENTION

Reference will now be made in detail to the presently preferred embodiment of the present invention, serve to explain the principles of the invention. These embodiments or examples are described in sufficient detail to enable those skilled in the art to practice the invention, and it is to be understood that other embodiments may be utilized, and that changes may be made without departing from the spirit of the present invention.

### EXAMPLE 1

### Self-Referenced Tunable Displacement Transducer Being Installed under Bridge Deck

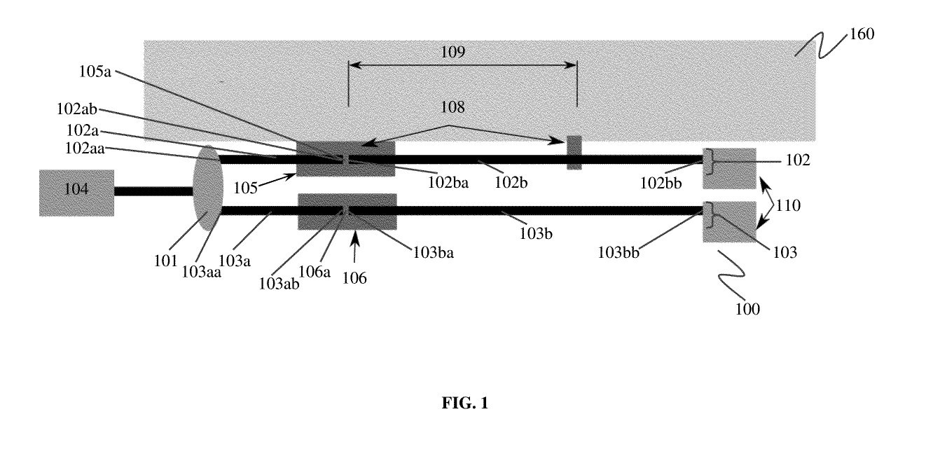

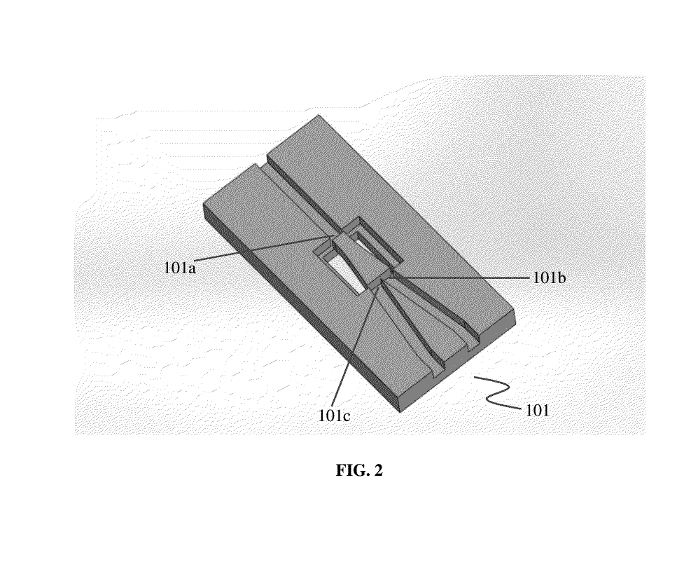

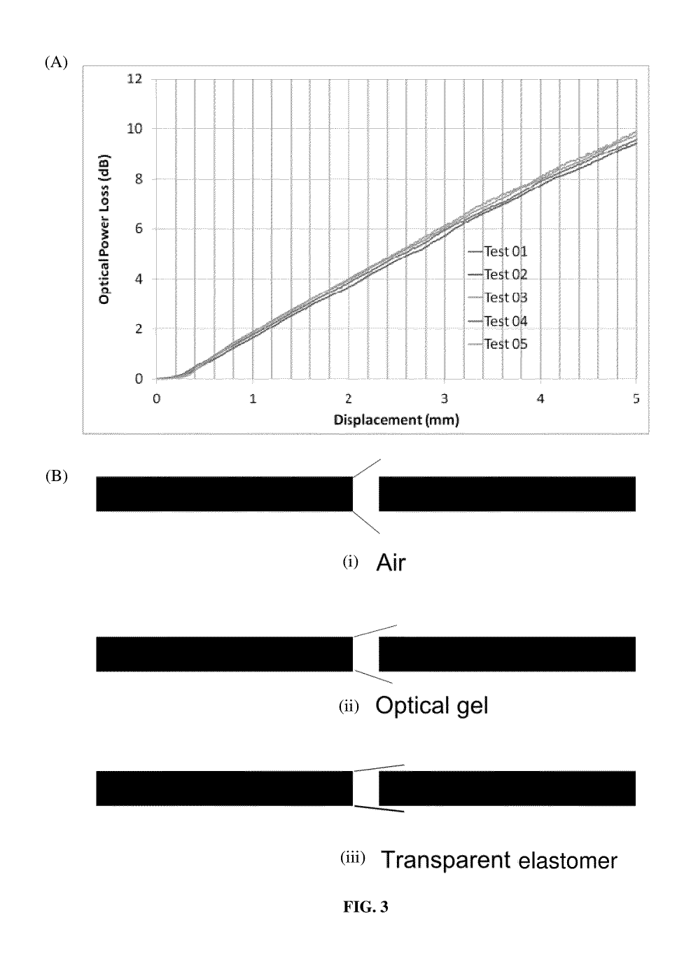

It is provided a self-referenced and tunable optical displacement transducer in the present invention. FIG. 1 shows a schematic diagram of the self-referenced and tunable optical displacement transducer of the present invention when it is installed under a bridge deck for monitoring any crack opening and measuring any displacement between certain points of the bridge. In this example, the transducer 100 includes an optical splitter 101, at least one transducing element 102 and a self-reference element 103, said optical splitter 101 comprising one inlet 101a and at least two outlets (101b, 101c) (FIG. 2), the optical fiber in the inlet 101a further comprising at least one light source, i.e. LED (104), which is coupled for transmission and split into at least two separated optical paths in the outlets (101b, 101c) and the proportion of light intensity in each of the outlets compared with the inlet is fixed; said transducing element 102 comprising a first optical fiber 102a and a second optical fiber 102b, said first optical fiber 102a having a first end face 102aa aligned along an axis and positioned in one of the outlets (101b) of optical splitter 101, a second end face 102ab of the first optical fiber 102a from the outlet 101b aligned along an axis and positioned with a small gap 105a between said second end face of the first optical fiber 102a and a first end face of a first reception assembly 105, the small gap 105a is filled by a material such as transparent solid/liquid/gas. Said transducer 100 further comprises at least one photo-detector 110 coupled for reception to said first reception assembly 105, said second optical fiber 102b of the transducing element 102 and said first reception assembly 105 being displaceable along said axis and relatively with respect to each other. Said self-reference element 103 comprises a first optical fiber 103a and a second optical fiber 103b. Said first optical fiber 103a of the self-reference element has a first end face 103aa aligned along an axis and positioned in one of the outlets 101c of the optical splitter 101, a second end face 103ab of the first optical fiber 103a from the outlet aligned along an axis and positioned with a small gap 106a between said second end face 103ab and a first end face of a second reception assembly 106, the small gap 106a is filled by a material such as transparent solid/liquid/gas. Said transducer 100 further comprises at least one photo-detector 110 coupled for reception to said second reception assembly 106, said second optical fiber 103b and said second reception assembly 106 being non-displaceable along said axis. In this example, the transducing element 102 of the transducer 100 is anchored under the bridge deck 160 at two fixed points 108 adjacent to two points of the bridge deck 160 where the distance between the two fixed points is gauge length 109. One of the two fixed points 108 on the transducer 100 is at the first reception assembly 105 while the other fixed point is along the second optical fiber 102b of the transducing element 102. Measuring and monitoring the change in the gauge length 109 within certain period of time can determine the crack size and integral strength of the building structure, i.e. the bridge deck in this example.

In one embodiment, both the first and second optical fibers are polymer optical fiber (POF) having a core diameter from 400 to 1,100 μm and a numerical aperture of about 0.5.

In another embodiment, said second end face of the first optical fiber and said first end face of the second optical fiber of the transducing element are inserted in an alignment sleeve, i.e., the first reception assembly 105.

In other embodiment, said second end face of the first optical fiber and said first end face of the second optical fiber of the self-reference element are inserted in an alignment sleeve, i.e., the second reception assembly 106.

In yet another embodiment, the material filled in the small gap of the coupler (i.e. the first or second reception assembly) between the first and second optical fibers of the transducing element and/or between the first and second optical fibers of the self-reference element comprises transparent elastomer (e.g. polydimethylsiloxane), optical gel and gas. Gas can be air or argon gas with a refractive index of 1.0003032; optical gel used herein can have a refractive index between 1.0 and 1.4.

In one of the embodiments, the optical splitter is made of a material with refractive index close to that of the core of the optical fiber. For example, the material can be polymethyl metharcylate.

### EXAMPLE 2

### Displacement Measuring System and Measurement Method Thereof

It is also provided that a displacement measuring system comprising at least one transducer associated to processing means, wherein said transducer is a transducer of the first aspect and said processing means are configured for analyzing a current or a voltage signal generated by said photo-detector.

Said processing means includes a digital acquisition board.

Said digital acquisition board includes a plurality of acquisition channels.

The displacement measuring system includes a plurality of transducers associated to said plurality of channels of the digital acquisition board.

The transducing elements and self-reference elements of said transducers are oriented along different axes.

The displacement is deduced from the ratio of light intensity measured by the displacement measuring system between one transducing element and the self-reference element.

FIG. 2 shows a basic diagram of an optical splitter that includes one inlet 101a which connects to a light source and two outlets (101b, 101c). One of the two outlets (101b) is connected to the transducing element 102 while the other outlet (101c) is connected to the self-reference element 103.

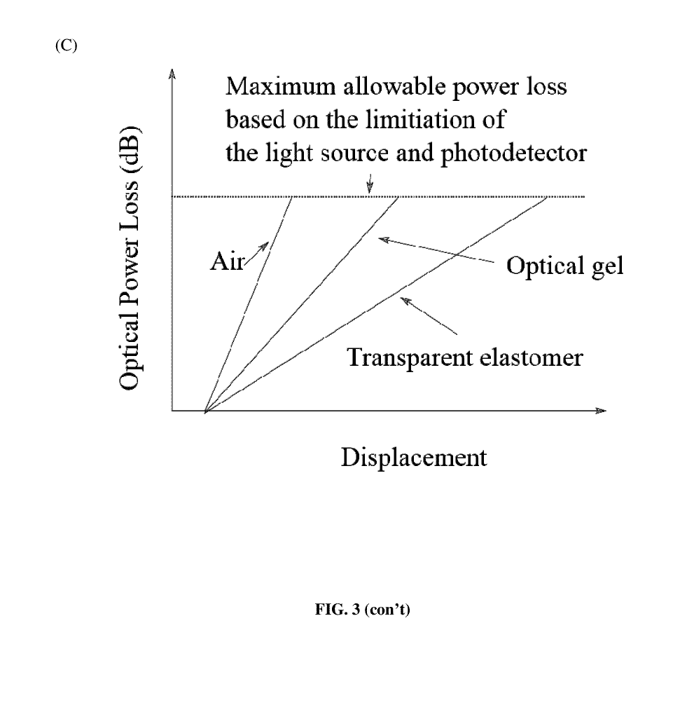

FIG. 3A shows results of the displacement measured by a linear variable differential transformer and the loss in optical power in log scale for the case that the small gap in the reception assembly (or “coupler” is used interchangeably hereinafter) is filled by air. The small gap can also be filled by transparent solid (e.g. polydimethylsiloxane, co-polymer of 3-(Trimethoxysilyl)propyl methacrylate and 2,2,3,3,4,4,5,5,6,6,7,7-Dodecafluoroheptyl methacrylate, etc.), liquid (e.g. optical gel), other gas (e.g. argon), or a mixture thereof so as to tune the sensitivity, that is the slope of FIG. 3A and the linear range. The measurement is repeated for five times. The coefficient of variation is 3.5% (maximum is less than 20%). From the test results as shown in FIG. 3A, the range of measureable displacement is about 5 times (1 mm diameter of the polymer optical fiber and 5 mm displacement). By filling different transparent materials in the gap, the range of measureable displacement can be increased.

FIG. 3B illustrates different cone size of the light outputted from the end face at 102ab/103ab, which are the second end face 102ab of the first optical fiber 102a of the transducing element 102 and the second end face 103ab of the first optical fiber 103a of the self-reference element 103. For the case where the small gap in the coupler is filled with air, due to the largest contrast of refractive index from the core of the polymer optical fiber among the three materials used in the present invention, the angle of refraction is the largest. Hence, with the same separation between the end faces 102ab/102ba and between 103ab/103ba, the amount of light coupled to the first end face 102ba of the second optical fiber of the transducing element or the amount of light coupled to the first end face 103ba of the second optical fiber of the self-reference element is the least among the three materials used in the present invention. On the other hand, by using transparent elastomer, e.g. polydimethylsiloxane, to fill the small gap in the coupler, the contrast of refractive index from the core of the polymer optical fiber is the least and hence, maximum amount of light is coupled to the end faces 102ba and 103ba from the corresponding end faces 102ab and 103ab, respectively. When an optical gel with refractive index in between air and transparent elastomer (e.g., between 1.0 and 1.4) is selected as the material to fill the small gap in the coupler, the amount of light coupled is in between the two materials as well. FIG. 3C is a hypothetical plot of the optical power loss against displacement of the first reception assembly of the transducing element when using different materials to fill the small gap in the coupler based on the assumption that the change of the optical power loss is linear to the change of displacement when using the other two materials than air. The dashed line in FIG. 3C represents the maximum allowable optical power loss according to the dynamic range of the light intensity of the light source and the photo-detector of the present invention. It is noteworthy that among the three materials used herein, air is more suitable for determining smaller crack size, i.e., more sensitive to change of crack size, than the other two materials; transparent elastomer is more suitable for determining larger crack size, i.e., relatively less sensitive; optical gel is in between air and transparent elastomer in terms of the sensitivity to crack size determination.

According to the method of the present invention, the optical power of the transducing element and self-reference element is measured by photo-detector connected at the other end face of the optical fibers. The optical power is converted to electrical current/voltage by simple low noise circuit.

The current/voltage is converted to voltage and it is measured by an analog-to-digit device. In this example, it is a programmed standalone microcontroller. The voltage is recorded in time domain and stored in the internal memory of the microcontroller. The stored data can be transferred to personal computer through universal serial bus. The present invention is low cost and can be incorporated in wireless sensor network easily.

### INDUSTRIAL APPLICABILITY

The present transducer is useful in monitoring and measuring crack size and integral strength of a structure without being affected by other environmental or external factors. The light interference is encountered by the self-reference element of the present transducer.

It is understood that the method/device/system described herein may be performed in different order, concurrently and/or together with other steps not mentioned herein but readily appreciated by one skilled in the art to obtain the method/device/system of the present invention. Without further elaboration, it is believed that one skilled in the art can, based on the description herein, modify the present invention without departing the spirit of the present invention and utilize the present invention to its fullest extend. All publication recited herein are hereby incorporated by reference in their entirety.

What is claimed is:

1. A self-referenced and tunable optical displacement transducer comprising an optical splitter, at least one transducing element and a self-reference element;
said optical splitter comprising one inlet and at least two outlets, an optical fiber in the inlet further comprising at least one light source coupled for transmission and split into at least two separated optical paths in the outlets and the proportion of light intensity in each of the outlets compared with the inlet is fixed;
each of said at least one transducing element comprising a first optical fiber and a second optical fiber, said first optical fiber of the transducing element comprising a first end face aligned along an axis and positioned in one of the outlets of the optical splitter, and a second end face from the outlet of the optical splitter aligned along an axis and positioned with a small gap between said second end face of the first optical fiber and a first end face of a first reception assembly, the small gap at the first reception assembly being filled by a material comprising transparent solid, liquid and gas;
said transducer further comprising at least one photo-detector coupled for reception to said first reception assembly, said second optical fiber of the transducing element and said first reception assembly being displaceable along said axis and relatively with respect to each other;
said self-reference element comprising a first optical fiber and a second optical fiber, said first optical fiber of the self-reference element comprising a first end face aligned along an axis and positioned in one of the outlets of the optical splitter, and a second end face from the outlet of the optical splitter aligned along an axis and positioned with a small gap between said second end face and a first end face of a second reception assembly, the small gap at the second reception assembly being filled by a material comprising transparent solid, liquid and gas;
said transducer further comprising at least one photo-detector coupled for reception to said second reception assembly, said second optical fiber of the self-reference element and said second reception assembly being non-displaceable along said axis.

2. The optical displacement transducer of claim 1, wherein the first and second optical fibers of either the transducing element or the self-reference element are polymer optical fiber with a core diameter from 400 to 1,100 μm and a numerical aperture of about 0.5 such that displacements in an order of at least five times the fiber core diameter are measurable.

3. The optical displacement transducer of claim 1, wherein the transparent solid filled the small gap at the first reception assembly or at the second reception assembly comprises polydimethylsiloxane, co-polymer of 3-(Trimethoxysilyl)propyl methacrylate and 2,2,3,3,4,4,5,5,6,6,7,7-Dodecafluoroheptyl methacrylate.

4. The optical displacement transducer of claim 1, wherein the liquid filled the small gap at the first reception assembly or at the second reception assembly comprises optical gel with a refractive index between 1.0 and 1.4.

5. The optical displacement transducer of claim 1, wherein the gas filled the small gap at the first reception assembly or at the second reception assembly comprises air, argon, and any gas with a refractive index of about 1.0003032.

6. The optical displacement transducer of claim 1, wherein the optical splitter is made of a material with a refractive index close to that of the core of the optical fibers.

7. The optical displacement transducer of claim 1, wherein the light sources and the photo-detector comprise off-the-shelf light emitting diodes and photodiodes.

8. A method of using the optical displacement transducer of claim 1 for determining crack size of a structure, said method comprising:
a) anchoring said optical displacement transducer onto said structure at two fixed points where the distance between the two fixed points is gauge length;
b) measuring optical power of the light transmitted from the light source through the optical splitter and further along the first optical fiber of the transducing element and then through the first reception assembly to the second optical fiber of the transducing element by the photo-detector;
c) converting the optical power measured in (b) into electrical current/voltage by simple low noise circuit;
d) further converting the current/voltage obtained from (c) into voltage and measuring the voltage by an analog-to-digit device to obtain an optical power loss data;
e) comparing the optical loss data obtained from (d) with a reference to calculate light intensity ratio of the optical loss data to the reference data in order to determine the crack size of said structure.

9. The method of claim 8, wherein the analog-to-digit device comprises a programmed standalone microcontroller.

10. The method of claim 9, wherein the voltage is recorded in time domain and stored in an internal memory of the microcontroller as the optical power loss data.

11. The method of claim 10, wherein the stored optical power loss data is transferrable to a personal computer through universal serial bus or through a wireless network for said comparing with the reference.
